(19) United States
(12) Patent Application Publication
(10) Pub. No.: US 2022/0413109 A1
(43) Pub. Date: Dec. 29, 2022

(54) DISTANCE MEASUREMENT SENSOR, DISTANCE MEASUREMENT SYSTEM, AND ELECTRONIC APPARATUS

(71) Applicant: SONY SEMICONDUCTOR SOLUTIONS CORPORATION, KANAGAWA (JP)

(72) Inventor: Kumiko MAHARA, KANAGAWA (JP)

(21) Appl. No.: 17/756,218

(22) PCT Filed: Nov. 13, 2020
(86) PCT No.: PCT/JP2020/042402

§ 371 Date: May 19, 2022

(30) Foreign Application Priority Data
Nov. 29, 2019 (JP) 2019-216557

(51) Int. Cl. G01S 7/497; G01S 17/10; G01S 17/89

(52) U.S. Cl. CPC G01S 7/497; G01S 17/10; G01S 17/89

(57) ABSTRACT

The present technology relates to a distance measurement sensor, a distance measurement system, and an electronic apparatus in which power consumption can be further reduced.

The distance measurement sensor includes a pixel array section where pixels that each. receive reflection light resulting from irradiation light applied by an illumination device and reflected by an object and output a detection. signal according to a quantity of the received light are two-dimensionally arranged, and a control section that controls an operation state of the illumination device according to an operation timing of the distance measurement sensor itself. The present technology is applicable to a distance measurement system that measures a distance to a subject, for example.

### TECHNICAL FIELD

The present technology relates to a distance measurement sensor, a distance measurement system, and an electronic apparatus. Specifically, the present technology relates to a distance measurement sensor, a distance measurement system, and an electronic apparatus in which power consumption can be further reduced.

### BACKGROUND ART

In ToF (Time of Flight) distance measurement, irradiation light is emitted from a light emission source such as an infrared laser diode to an object, and reflection light resulting from the irradiation light reflected by a surface of the object is detected by a distance measurement sensor. Then, the distance to the object is calculated according to the flight time required from emission of the irradiation light to reception of the reflection light.

Since power consumption in the light emission source having emitted the irradiation light is large, various technologies for suppressing power consumption have been proposed. For example, in order to suppress power consumption, a distance sensor that controls a light emission cycle and a light receiving timing according to the intensity of background light is disclosed (see PTL 1, for example).

### CITATION LIST

### Patent Literature

[PTL 1]

Japanese Patent Laid-open No. 2017-83243

### SUMMARY

### Technical Problem

In distance measurement sensors, further reduction in power consumption has been desired.

The present technology has been achieved in view of the abovementioned circumstances. With the present technology, power consumption can be further reduced.

### Solution to Problem

A distance measurement sensor according to a first aspect of the present technology includes a pixel array section where pixels that each receive reflection light resulting from irradiation light applied by an illumination device and reflected by an object and output a detection signal according to a quantity of the received light are two-dimensionally arranged, and a control section that controls an operation state of the illumination device according to an operation timing of the distance measurement sensor itself.

A distance measurement system according to a second aspect of the present technology includes an illumination device that applies irradiation light to an object, and a distance measurement sensor that receives reflection light resulting from the irradiation light reflected by the object, in which the distance measurement sensor includes a pixel array section where pixels that each output a detection signal according to a quantity of the received reflection light are two-dimensionally arranged, and a control section that controls an operation state of the illumination device according to an operation timing of the distance measurement sensor itself.

An electronic apparatus according to a third aspect of the present technology includes a distance measurement system that includes an illumination device that applies irradiation light to an object and a distance measurement sensor that receives reflection light resulting from the illumination light reflected by the object, the distance measurement sensor including a pixel array section where pixels that each output a detection signal according to a quantity of the received reflection light are two-dimensionally arranged and a control section that controls an operation state of the illumination device according to an operation timing of the distance measurement sensor itself.

According to the first to third aspects of the present technology, the pixel array section where pixels that each receive reflection light resulting from the irradiation light applied by the illumination device and reflected by the object are two-dimensionally arranged is provided, and the operation state of the illumination device is controlled according to the operation timing of the distance measurement sensor.

The distance measurement sensor, the distance measurement system, or the electronic apparatus may be an independent unit, or may be a module to be incorporated in another unit.

### BRIEF DESCRIPTION OF DRAWINGS

FIG. 1 is a block diagram depicting a configuration example of a distance measurement system to which the present technology is applied.

FIG. 2 is a diagram for explaining the principle of indirect ToF distance measurement.

FIG. 3 is a diagram for explaining the principle of indirect ToF distance measurement.

FIG. 4 is a block diagram depicting a detailed configuration example of an illumination device and a distance measurement sensor.

FIG. 5 is a diagram for explaining types of an operation state of the illumination device.

FIG. 6 is a sequence diagram illustrating a status transition from activation to light emission.

FIG. 7 is a sequence diagram illustrating a status transition from light emission to a halt.

FIG. 8 is a diagram for explaining a timing for carrying out a calibration operation.

FIG. 9 is a diagram for explaining a timing for carrying out a calibration operation.

FIG. 10 is a flowchart for explaining an illumination device status control process.

FIG. 11 is a block diagram depicting a detailed configuration example of the illumination device and a distance measurement sensor according to a modification.

FIG. 12 depicts perspective views of a chip configuration example of the distance measurement sensor.

FIG. 13 is a block diagram of a distance measurement system that performs another light emission control method as a comparative embodiment.

FIG. 14 is a block diagram depicting a configuration example of an electronic apparatus to which the present technology is applied.

FIG. 15 is a block diagram depicting an example of schematic configuration of a vehicle control system.

FIG. 16 is a diagram of assistance in explaining an example of installation positions of an outside-vehicle information detecting section and an imaging section.

### DESCRIPTION OF EMBODIMENT

Hereinafter, a mode for carrying out the present technology (hereinafter, referred to as an embodiment) will be explained. It is to be noted that components having substantially the same functional structure are denoted by the same reference signs throughout the present description and the drawings, and a redundant explanation thereof will be omitted. An explanation will be given in the following order.

1. General Configuration Example of Distance Measurement System

2. Principle of Indirect ToF Distance Measurement

3. Configuration Example of Distance Measurement Sensor and Illumination Device

4. Status of Illumination Device

5. Status Transition from Activation to Light Emission

6. Status Transition from Light Emission to Halt

7. Timing for Carrying Out Calibration Operation

8. Flowchart of Illumination Device Status Control Process

9. Modification of Distance Measurement Sensor

10. Chip Configuration Example of Distance Measurement Sensor

11. Comparison with Any Other Light Emission Control Method

12. Examples of Application to Electronic Apparatus

13. Examples of Application to Mobile Body

### <1. General Configuration Example of Distance Measurement System>

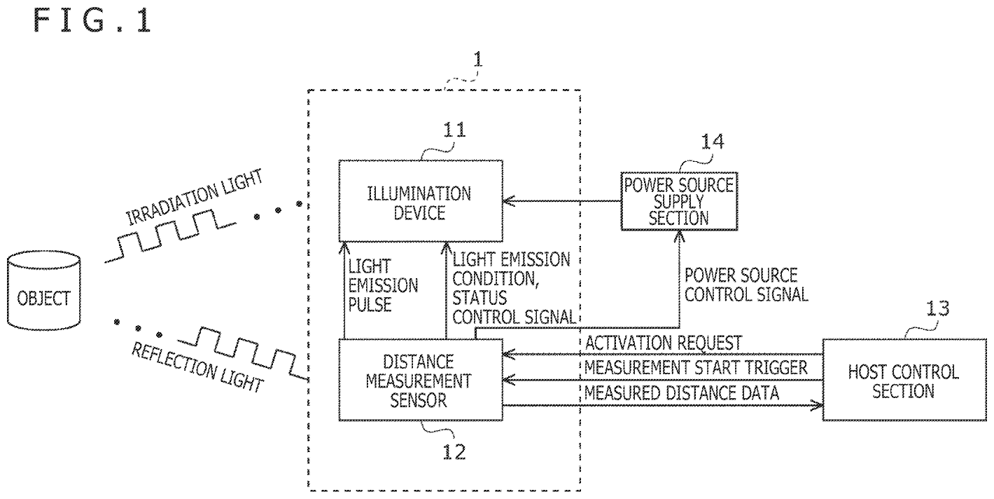

FIG. 1 is a block diagram depicting a configuration example of a distance measurement system to which the present technology is applied.

A distance measurement system 1 includes an illumination device 11 and a distance measurement sensor 12. According to a command sent from a host control section 13 which is a control section of a host apparatus that has the distance measurement system 1 installed therein, the distance measurement system 1 measures a distance to a predetermined object which is a subject, and outputs the measured distance data to the host control section 13.

More specifically, the illumination device 11 includes a light source which is an infrared laser diode, for example, and applies irradiation light to a predetermined object which is a subject, according to a light emission condition and a light emission pulse supplied from the distance measurement sensor 12. The light emission pulse is a pulse signal of a predetermined modulation frequency (e.g., 20 MHz) indicating a light emission (on/off) timing. The light emission condition includes light source setting information such as a light emission intensity, an irradiation area, and an irradiation type, for example. Under the light emission condition supplied from the distance measurement sensor 12, the illumination device 11 emits light while modulating the light according to the light emission pulse.

An activated or halted state of a power source of the illumination device 11 is decided according to whether or not a power source is supplied from a power source supply section 14. On/off of power supply from the power source supply section 14 to the illumination device 11 is decided by a power source control signal that is supplied from the distance measurement sensor 12 to the power source supply section 14.

Moreover, an operation status of the illumination device 11 that is in an activated state is decided by a status control signal that is supplied from the distance measurement sensor 12. The operation statuses during the activated state are a light emission status, a light emission ready status, an activation ready status, and a standby status, which will be explained later.

The distance measurement sensor 12 is activated according to an activation request supplied from the host control section 13.

The distance measurement sensor 12 controls operation of the illumination device 11 in line with an operation state of the distance measurement sensor 12 itself, or in line with driving of pixels, for example. More specifically, the distance measurement sensor 12 switches the on/off of a power source supply to the illumination device 11 by supplying a power source control signal to the power source supply section 14 and thereby controls the activation and halt of the illumination device 11. In addition, the distance measurement sensor 12 controls various operation statuses of the illumination device 11 during the activated state by supplying a predetermined status control signal to the illumination device 11.

In a case where a measurement start trigger indicating start of distance measurement is supplied from the host control section 13, the distance measurement sensor 12 generates a light emission pulse and supplies the light emission pulse to the illumination device 11 to cause the illumination device 11 to emit irradiation light. Further, the distance measurement sensor 12 starts a light receiving operation to receive reflection light resulting from the irradiation light reflected by an object, to generate measured distance data according to the light reception result and output the measured distance data to the host control section 13. A light emission condition is supplied to the illumination device 11 at any timing prior to supply of the light emission pulse to the illumination device 11, and is set in advance.

The host control section 13 controls the whole of the host apparatus having the distance measurement system 1 installed therein. In a case of causing the distance measurement system 1 to conduct distance measurement, the host control section 13 activates the whole of the distance measurement system 1 by supplying an activation request to the distance measurement sensor 12. Further, the host control section 13 supplies a light emission condition for application of irradiation light from the illumination device 11 and a measurement start trigger indicating start of distance measurement, to the distance measurement sensor 12.

The host control section 13 includes a computer such as a CPU (central processing unit), an MPU (microprocessor unit), and an FPGA (field-programmable gate array) installed in the host apparatus, or an application program that is operated in the computer, for example. Alternatively, in a case where the host apparatus includes a smartphone, the host control section 13 may include an AP (application processor) or an application program that is operated in the AP.

The power source supply section 14 switches the on/off of power source supply to the illumination device 11 according to a power source control signal supplied from the distance measurement sensor 12. The power source supply section 14 may be a section of the host apparatus, or may be a section of the distance measurement system 1.

The distance measurement system 1 performs measurement distance according to a light reception result of reflection light by using a predetermined distance measurement method such as an indirect ToF (Time of Flight) method, a direct ToF method, or a Structured Light method. In the indirect ToF method, a flight time from emission of irradiation light to reception of reflection light is detected from a phase difference, and the distance to an object is calculated. In the direct ToF method, a flight time from emission of irradiation light to reception of reflection light is directly measured, and the distance to an object is calculated. In the Structured Light method, pattern light is applied as irradiation light, and the distance to an object is calculated according to distortion of the pattern of received light.

A distance measurement method to be performed by the distance measurement system 1 is not limited to a particular method. Hereinafter, in reference to an example in which the distance measurement system 1 conducts indirect ToF distance measurement, specific operations of the distance measurement system 1 will be explained.

### <2. Principle of Indirect ToF Distance Measurement>

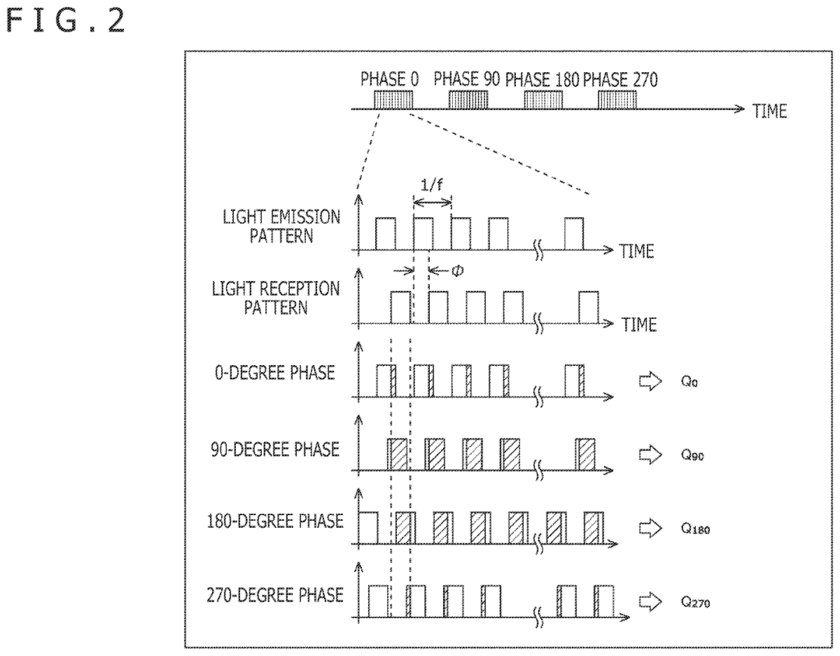

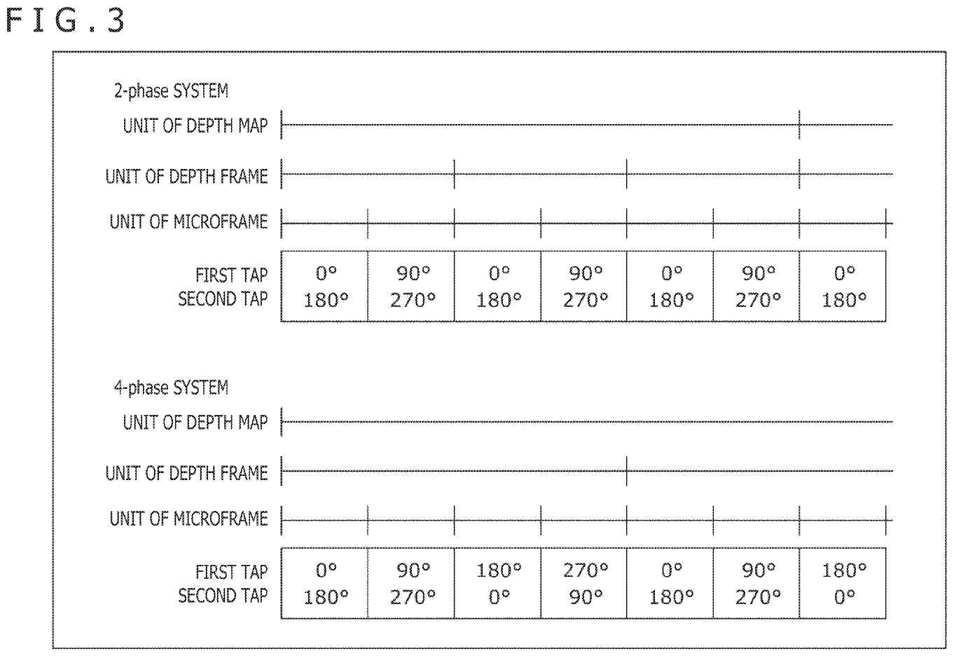

First, a brief description will be given of the principle of distance measurement using the indirect ToF method, with reference to FIGS. 2 and 3.

A depth value d [mm] which corresponds to the distance from the distance measurement system 1 to an object can be obtained from the following expression (1).

d=½·c·Δt (1)

In expression (1), Δt represents a length of time required for irradiation light emitted by the illumination device 11 to enter the distance measurement sensor 12 after being reflected by the object, and c represents a light speed.

As irradiation light applied by the illumination device 11, pulse light having a light emission pattern in which on/off is repeated at high speed and at a predetermined modulation frequency c, as depicted in FIG. 2, is adopted. One cycle T of the light emission pattern is 1/f. The distance measurement sensor 12 detects reflection light (received light pattern) with a phase shift corresponding to the time At which is required for the light to travel from the illumination device 11 to the distance measurement sensor 12. When the phase shift amount (phase difference) between the light emission pattern and the light reception pattern is defined as φ, the time Δt can be obtained from the following expression (2).

$$Δ t = \frac{1}{f} \cdot \frac{ϕ}{2 π} \qquad ( 2 )$$

Accordingly, according to expressions (1) and (2), the depth value d from the distance measurement system 1 to the object can be obtained from the following expression (3).

$$d = \frac{C ϕ}{4 π f} \qquad ( 3 )$$

Next, a method for calculating the phase difference φ will be explained.

ON/OFF of each pixel in a pixel array formed in the distance measurement sensor 12 is repeated at high speed according to the modulation frequency, and electric charge is stored in each pixel only during an ON period.

The distance measurement sensor 12 sequentially switches the ON/OFF executing timing of each pixel in the pixel array such that electric charges are stored at the executing timings, and outputs detection signals corresponding to the stored electric charges.

As the ON/OFF executing timings, there are, for example, four timings: the 0-degree phase; the 90-degree phase; the 180-degree phase, and the 270-degree phase.

At the executing timing of the 0-degree phase, an ON timing (light receiving timing) of each pixel in the pixel array is set in a phase coinciding with the phase of pulse light emitted by the illumination device 11, that is, a light emission pattern.

At the executing timing of the 90-degree phase, an ON timing (light receiving timing) of each pixel in the pixel array is set in a phase delayed, by 90 degrees, from the phase of pulse light (light emission pattern) emitted by the illumination device 11.

At the executing timing of the 180-degree phase, an ON timing (light receiving timing) of each pixel in the pixel array is set in a phase delayed, by 180 degrees, from the phase of pulse light (light emission pattern) emitted by the illumination device 11.

At the executing timing of the 270-degree phase, an ON timing (light receiving timing) of each pixel in the pixel array is set in a phase delayed, by 270 degrees, from the phase of pulse light (light emission pattern) emitted by the illumination device 11.

The distance measurement sensor 12 sequentially switches a light receiving timing to the 0-degree phase, the 90-degree phase, the 180-degree phase, and the 270-degree phase, in this order, and acquires a quantity of reflection light (stored electric charges) received at each light receiving timing. In FIG. 2, hatched lines are provided to indicate reflection light entering timings during the light receiving timings (ON timings) in the respective phases.

When electric charges that are stored when a light receiving timing is set to the 0-degree phase, the 90-degree phase, the 180-degree phase, and the 270-degree phase are defined as Q₀, Q₉₀, Q₁₈₀, and Q₂₇₀, respectively, as depicted in FIG. 2, the phase difference φ can be calculated from the following expression (4) with use of Q₀, Q₉₀, Q₁₈₀, and Q₂₇₀.

$$ϕ = Arctan \frac{{Q}_{90} - {Q}_{270}}{{Q}_{180} - {Q}_{0}} \qquad ( 4 )$$

When the phase difference φ obtained from expression (4) is substituted into expression (3), the depth value d from the distance measurement system 1 to the object can be calculated.

Also, a confidence degree conf is a value representing the intensity of light received by each pixel, and can be calculated from the following expression (5), for example.

conf=\sqrt{(Q₁₈₀ −Q₀)²+(Q₉₀−Q₂₇₀)²} (5)

The distance measurement sensor 12 calculates the depth value d which indicates the distance from the distance measurement system 1 to the object, according to a detection signal supplied for each pixel in the pixel array. Then, a depth map in which the depth values d are stored as respective pixel values of the pixels and a confidence degree map in which confidence degrees conf are stored as respective pixel values of the pixels are generated, and are outputted to the outside.

In the pixel configuration in the distance measurement sensor 12, two electric charge storing sections are provided to each pixel in the pixel array, for example. Two electric charge storing sections are referred to as a first tap and a second tap. Electric charges are stored alternately in the two electric charge storing sections which are the first tap and the second tap, so that detection signals at two light receiving timings of inverted phases, for example, the 0-degree phase and the 180-degree phase, can be obtained in one frame.

Here, the distance measurement sensor 12 generates and outputs a depth map and a confidence degree map by either a 2-Phase system or a 4-Phase system.

The upper part of FIG. 3 depicts 2-Phase depth map generation.

In the 2-Phase system which is illustrated in the upper part of FIG. 3, detection signals of the 0-degree phase and the 180-degree phase are obtained in a first frame, and next, detection signals of the 90-degree phase and the 270-degree phase are obtained in a second frame. Accordingly, the detection signals of the four phases are obtained, and a depth value d can be obtained by expression (3).

In the 2-Phase system, a unit (one frame) for generating detection signals of the 0-degree phase and the 180-degree phase or the 90-degree phase and the 270-degree phase is referred to as a microframe. Data regarding the four phases can be obtained by two microframes. Accordingly, a depth value d in each pixel can be obtained from data regarding two microframes. A frame in which the depth values d are stored as respective pixel values of the pixels is referred to as a depth frame. In this case, one depth frame includes two microframes.

Furthermore, the distance measurement sensor 12 obtains multiple depth frames while changing the light emission condition such as the light emission intensity or the modulation frequency, and generates a final depth map from the multiple depth frames. That is, one depth map is generated from multiple depth frames. In the example in FIG. 3, a depth map is generated from three depth frames. It is to be noted that one depth frame may be directly outputted as a depth map. That is, one depth map may include one depth frame.

The lower part of FIG. 3 depicts 4-Phase depth map generation.

In the 4-Phase system which is illustrated in the lower part of FIG. 3, detection signals of the 180-degree phase and the 0-degree phase are obtained in a third frame subsequent to the first and second frames, and detection signals of the 270-degree phase and the 90-degree phase are obtained in the following fourth frame. That is, detection signals of all the four phases which are the 0-degree phase, the 90-degree phase, the 180-degree phase, and the 270-degree phase are obtained in each of the first tap and the second tap, and a depth value d can be obtained by expression (3). Accordingly, in the 4-Phase system, one depth frame includes four microframes, and one depth map is generated from multiple depth frames obtained under different light emission conditions.

In the 4-Phase system, detection signals of all the four phases can be obtained in each of the taps (the first tap and the second tap). Accordingly, variation in characteristics between the taps in each pixel, i.e., the sensitivity difference between the taps, can be eliminated.

On the other hand, in the 2-Phase system, a depth value d to the object can be obtained from data regarding two microframes. Thus, distance measurement can be conducted at a frame rate twice as high as that in the 4-Phase system. Variation in characteristics between the taps is controlled by correction parameters such as a gain and an offset.

In the following explanation, it is assumed that the distance measurement sensor 12 is driven in the 4-Phase system, although the distance measurement sensor 12 can be driven in either the 2-Phase system or the 4-Phase system.

### <3. Configuration Example of Distance Measurement Sensor and Illumination Device>

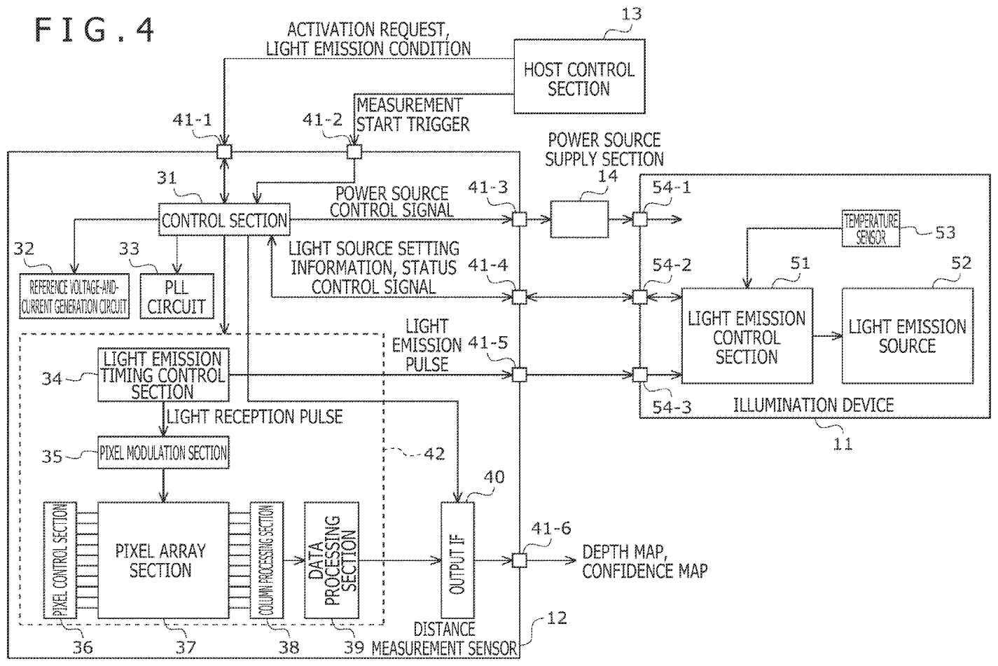

FIG. 4 is a block diagram depicting a detailed configuration example of the illumination device 11 and the distance measurement sensor 12. It is to be noted that FIG. 4 also illustrates the host control section 13 in order to facilitate understanding.

The distance measurement sensor 12 includes a control section 31, a reference voltage-and-current generation circuit 32, a PLL circuit 33, a light emission timing control section 34, a pixel modulation section 35, a pixel control section 36, a pixel array section 37, a column processing section 38, a data processing section 39, an output IF 40, and input/output terminals 41-1 to 41-6. The light emission timing control section 34, the pixel modulation section 35, the pixel control section 36, the pixel array section 37, the column processing section 38, and the data processing section 39 constitute a pixel array block 42.

The illumination device 11 includes a light emission control section 51, a light emission source 52, a temperature sensor 53, and input/output terminals 54-1 to 54-3.

An activation request and a light emission condition are supplied from the host control section 13 to the control section 31 of the distance measurement sensor 12 via the input/output terminal 41-1, and a measurement start trigger is supplied from the host control section 13 to the control section 31 via the input/output terminal 41-2. The measurement start trigger is supplied from the host control section 13 to the distance measurement sensor 12 in unit of depth map. In unit of depth map, the distance measurement sensor 12 is to output measured distance data.

The control section 31 is activated according to the activation request supplied from the host control section 13, and controls an operation of the entire distance measurement sensor 12 and the illumination device 11.

More specifically, upon receiving an activation request supplied from the host control section 13, the control section 31 supplies, as a power source control signal, a power supply signal ON (High) to the power source supply section 14 via the input/output terminal 41-3, so that the illumination device 11 is activated. In addition, the control section 31 activates the reference voltage-and-current generation circuit 32, the PLL circuit 33, the pixel array block 42, and the output IF 40.

Then, upon receiving a light emission condition supplied from the host control section 13, the control section 31 prepares to drive the pixel array block 42 according to the light emission condition, and supplies light source setting information such as a light emission intensity, an irradiation area, and an irradiation type to the illumination device 11 via the input/output terminal 41-4, so that light source setting is performed. In addition, the control section 31 controls the operation status of the illumination device 11 in line with the operation of the distance measurement sensor itself by supplying a predetermined status control signal to the illumination device 11 via the input/output terminal 41-4.

In addition, the control section 31 supplies information regarding a modulation frequency and a light emission time period, which is a portion of the light emission condition, to the light emission timing control section 34 of the pixel array block 42. The light emission time period indicates an integration period per one microframe.

The reference voltage-and-current generation circuit 32 generates a reference voltage and a reference current that are necessary for a light receiving operation (exposure operation) in each pixel in the pixel array section 37. The reference voltage-and-current generation circuit 32 supplies the generated reference voltage and reference current to the sections in the sensor.

The PLL (phase locked loop) circuit 33 generates various clock signals that are necessary for a light receiving operation (exposure operation) in each pixel in the pixel array section 37, and supplies the clock signals to the sections in the sensor.

The light emission timing control section 34 generates a light emission pulse in reference to the information regarding the modulation frequency and the light emission time period supplied from the control section 31, and supplies the light emission pulse to the illumination device 11 via the input/output terminal 41-5. The light emission pulse is a pulse signal of the modulation frequency supplied from the control section 31. The illumination device 11 emits irradiation light according to the light emission pulse.

Further, the light emission timing control section 34 generates a light reception pulse for reception of reflection light in synchronization with the light emission pulse, and supplies the light reception pulse to the pixel modulation section 35. The phase of the light reception pulse is delayed from that of the light emission pulse by 0 degree, 90 degrees, 180 degrees, or 270 degrees, in the abovementioned manner. The light emission timing control section 34 also drives the pixel control section 36, the column processing section 38, and the data processing section 39 according to the light reception pulse.

The pixel modulation section 35 switches an electric charge storing operation between the first tap and the second tap in each pixel in the pixel array section 37, according to the light reception pulse supplied from the light emission timing control section 34.

Under the driving control of the light emission timing control section 34, the pixel control section 36 controls a stored electric charge resetting operation and a reading operation in each pixel in the pixel array section 37.

The pixel array section 37 includes a plurality of pixels that are two-dimensionally arranged into a matrix shape. Each pixel in the pixel array section 37 receives reflection light under the control of the pixel modulation section 35 and the pixel control section 36, and supplies a detection signal corresponding to the quantity of the received light to the column processing section 38.

The column processing section 38 includes a plurality of AD (Analog to Digital) conversion sections. The AD conversion sections are disposed for respective pixel rows in the pixel array section 37, and each perform noise elimination and AD conversion on detection signals outputted from predetermined pixels in the corresponding pixel row. As a result, digital detection signals having undergone the AD conversion are supplied from the column processing section 38 to the data processing section 39.

The data processing section 39 calculates depth values d for the respective pixels according to the AD-converted detection signals of the pixels supplied from the column processing section 38, and generates a depth frame in which the depth values d are stored as pixel values of the respective pixels. Further, the data processing section 39 generates a depth map from one or more depth frames. In addition, the data processing section 39 calculates confidence degrees conf in reference to the detection signals of the respective pixels, generates a confidence degree frame in which the confidence degrees conf are stored as pixel values of the respective pixels, corresponding to the depth frame, and further generates a confidence degree map corresponding to the depth map. The data processing section 39 supplies the generated depth map and the generated confidence degree map to the output IF 40.

The output IF 40 converts the depth map and the confidence degree map supplied from the data processing section 39 into a signal format (e.g., MIPI: Mobile Industry Processor Interface) conforming to the input/output terminal 41-6, and outputs the converted data through the input/output terminal 41-6. The depth map and the confidence degree map outputted through the input/output terminal 41-6 are supplied as measured distance data to the host control section 13.

Meanwhile, when a power source is supplied to the illumination device 11 through the input/output terminal 54-1, the illumination device 11 is activated. When the power source supply is interrupted, the illumination device 11 is stopped. A power source (power source voltage) supplied through the input/output terminal 54-1 is supplied to the sections in the device.

The light emission control section 51 of the illumination device 11 includes a laser driver or the like. The light emission control section 51 drives the light emission source 52 according to the light emission pulse and the light source setting information supplied from the distance measurement sensor 12 via the input/output terminals 54-2 and 54-3. In addition, the light emission control section 51 can output a light source temperature supplied from the temperature sensor 53, to the control section 31 of the distance measurement sensor 12 via the input/output terminal 54-2 and the input/output terminal 41-4.

The light emission source 52 includes one or more laser sources such as VCSELs (Vertical Cavity Surface Emitting Laser), for example. Under the driving control of the light emission control section 51, the light emission source 52 emits irradiation light in such a way that a predetermined light emission intensity, a predetermined irradiation area, a predetermined irradiation type, a predetermined modulation frequency, and a predetermined light emission time period are achieved.

The temperature sensor 53 is disposed near the light emission source 52, detects a light source temperature, and supplies the light source temperature to the light emission control section 51.

In FIG. 4, the multiple input/output terminals 41-1 to input/output terminal 41-6 and the multiple input/output terminals 54-1 to 54-3 are separately provided for convenience of explanation. Alternatively, a single terminal (terminal group) equipped with multiple input/output contacts may be provided.

Information which is exchanged between the host control section 13 and the distance measurement sensor 12 and between the distance measurement sensor 12 and the illumination device 11 may be transmitted in the form of a control signal via a plurality of control lines, or may be transmitted by register setting in serial communication using an SPI (Serial Peripheral Interface), an I2C (Inter-Integrated Circuit), or the like. Thus, the operation state of the illumination device 11 can be controlled by serial communication.

In the distance measurement sensor 12 having the abovementioned configuration, the control section 31 controls the overall operation of the distance measurement sensor 12, and further controls activation and halt of the illumination device 11 and various operation statuses of the illumination device 11 that is in the activated state, in line with the overall operation of the distance measurement sensor 12. Since the distance measurement sensor 12 controls the operation of the illumination device 11 in line with the operation state of the distance measurement sensor 12 itself, power consumption in the illumination device 11 can be reduced, and the total power consumption in the distance measurement system 1 can be reduced.

### <4. Status of Illumination Device>

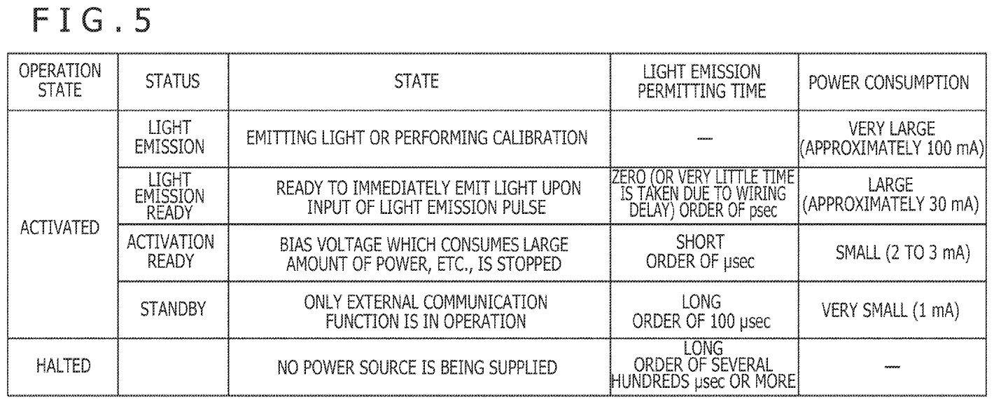

FIG. 5 illustrates the kinds of the operation states (statuses) of the illumination device 11 which is controlled by the distance measurement sensor 12.

The operation state of the illumination device 11 is classified into two states, i.e., an activated state and a halted state, according to whether or not a power source is being supplied from the power source supply section 14. In the activated state, a power source is being supplied from the power source supply section 14. In the halted state, no power source is being supplied from the power source supply section 14.

The activated state of the illumination device 11 is further classified (classification into sub-states) into four operation states, i.e., a light emission state, a light emission ready state, an activation ready state, and a standby state. The activated state and the halted state as well as the four operation states which are the light emission state, the light emission ready state, the activation ready state, and the standby state included in the activated state are also referred to as statuses.

In the light emission state, the light emission source 52 is emitting light, or the illumination device 11 is not emitting light but is carrying out a calibration to check an operation by performing an operation similar to a light emitting operation. Among the statuses, the light emission state consumes the largest quantity of power, which is approximately 100 mA, for example.

In the light emission ready state, light can be emitted immediately in a case where a light emission pulse is input. The length of time required for enabling light emission is almost zero at a wiring delay level, and is in the order of psec, for example, if any. The quantity of power which is consumed in the light emission ready state is the second largest next to the quantity in the light emission state. The quantity of power consumed in the light emission ready state is approximately 30 mA, for example.

In the activation ready state, a bias voltage, etc., which consumes a large quantity of power is stopped. The length of time required for enabling light emission is relatively short, and is in the order of psec, for example. The quantity of power which is consumed in the activation ready state is small, and is approximately 2 to 3 mA, for example.

In the standby state, only the external communication function is activated. The standby state is a state (Always ON state) in which, in a case where a notification is given from the outside, the light emitting function can immediately be activated to emit light. The length of time required for enabling light emission is relatively long, and is in the order of 100 μsec, for example. The quantity of power which is consumed in the standby state is excessively small, and is approximately 1 mA, for example.

In the halted state, no power source is supplied. In the halted state, since a post-activation, initial setting process or the like is required, the length of time required for enabling light emission is long, and is in the order of several hundreds of μsec, for example.

<5. Status Transition from Activation to Light Emission>

Next, a status transition in a flow of a transition from the halted state to the activated state of the illumination device 11 to emit irradiation light and the relation with a control signal that is supplied to the illumination device 11 during the transition will be explained.

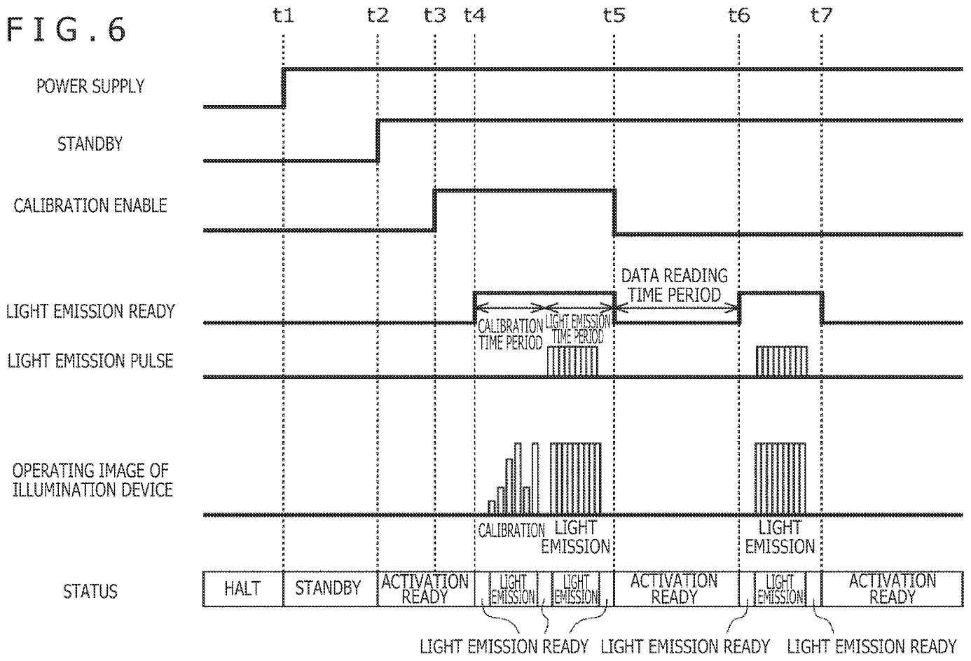

FIG. 6 is a sequence diagram depicting a status transition in which a transition from the halted state to the activated state of the illumination device 11 is made to emit irradiation light.

The status of the illumination device 11 is controlled by a power supply signal which is a power source control signal and three status control signals which are a standby signal, a calibration enable signal, and a light emission ready signal. The power supply signal is supplied from the distance measurement sensor 12 to the power source supply section 14. The status control signals are supplied from the distance measurement sensor 12 directly to the illumination device 11.

The initial operation state of the illumination device 11 is the halted state. In this state, all of the power supply signal, the standby signal, the calibration enable signal, and the light emission ready signal are OFF (Low).

At first, at time t1, the power supply signal is set to the ON (High) state, so that a power source is supplied from the power source supply section 14 to the illumination device 11. Accordingly, the status of the illumination device 11 is changed from the halted state to the standby state.

Next, at time t2, the standby signal is set to the ON (High) state. Accordingly, the status of the illumination device 11 is changed from the standby state to the activation ready state.

Then, at time t3, the calibration enable signal is set to the ON (High) state. Thereafter, at time t4, the light emission ready signal is set to the ON (High) state. When the light emission ready signal is set to the ON state, the status of the illumination device 11 transitions from the activation ready state to the light emission ready state. In addition, in a case where the calibration enable signal is in the ON state when the light emission ready signal is set to the ON state, the illumination device 11 carries out a calibration operation. In a case of performing the first light emission after the standby signal is changed to the ON state, the control section 31 sets the calibration enable signal to the ON state such that a calibration operation is carried out without fail.

At a predetermined timing after the end of the calibration operation carried out on and after time t4, a light emission pulse is supplied from the distance measurement sensor 12 to the illumination device 11. Accordingly, the illumination device 11 emits irradiation light in synchronization with the light emission pulse. The status of the illumination device 11 is the light emission state during a calibration operation and during emission of irradiation light.

At time t5 at which a fixed time period has elapsed from the end of supply of the light emission pulse, the calibration enable signal and the light emission ready signal are each set to the OFF (Low) state. Accordingly, the status of the illumination device 11 transitions from the light emission ready state to the activation ready state.

The time period between time t5 and time t6 corresponds to a data reading time period in which the distance measurement sensor 12 reads out, from the pixel array section 37, a detection signal corresponding to an accumulated electric charge stored in each pixel and supplies the detection signal to the column processing section 38.

Then, at time t6, the light emission ready signal is set to the ON state. After the elapse of a certain time period from setting to the ON state of the light emission ready signal, the illumination device 11 emits irradiation light in synchronization with a light emission pulse supplied from the distance measurement sensor 12 to the illumination device 11. When the light emission ready signal is set to the ON state at time t6, a calibration operation is not performed because the calibration enable signal is in the OFF state. The status of the illumination device 11 is the light emission ready state when the light emission ready signal is in the ON state. Further, in this state, when the light emission pulse is supplied, the status of the illumination device 11 is changed to the light emission state.

At time t7, the light emission ready signal is set to the OFF state. Accordingly, the status of the illumination device 11 is changed from the light emission ready state to the activation ready state. This state is identical to the state after time t2. At time t7 or later, a calibration operation is carried out, and irradiation light is emitted, as in time t3 and time t4, in a case where both the calibration enable signal and the light emission ready signal are set to the ON state, or irradiation light is emitted without a calibration operation, as in time t6, in a case where only the light emission ready signal is set to the ON state.

<6. Status Transition from Light Emission to Halt>

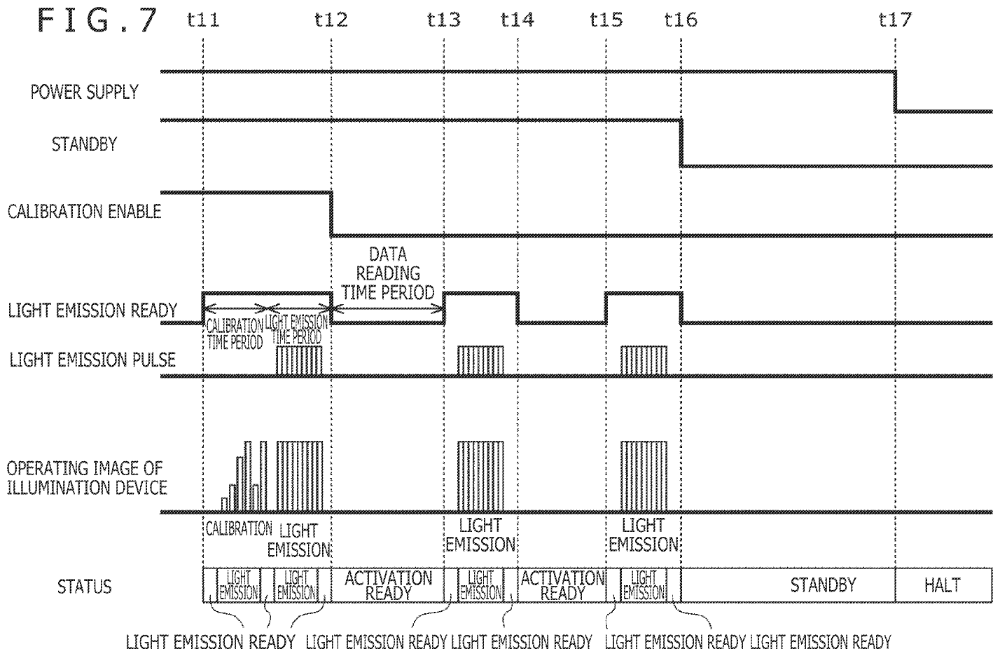

Next, a status transition of a transition from the light emission state to the halted state of the illumination device 11 will be explained with reference to FIG. 7.

Signals for controlling irradiation-light emission operations during a time period from time t11 to time t14 are similar to those for controlling the irradiation-light emission operations during the time period from time t4 to time t7 in FIG. 6, and thus, an explanation thereof will be omitted.

During the light emission time period until time t14, irradiation light is emitted in synchronization with a light emission pulse. Thereafter, during a time period from time t14 to time t15, the light emission ready signal is controlled to the OFF state, so that the status of the illumination device 11 transitions from the light emission ready state to the activation ready state. A time period from time t14 to time t15 corresponds to a data reading time period in which, in the distance measurement sensor 12, a detection signal corresponding to an electric charge stored in each pixel is read out from the pixel array section 37 and is supplied to the column processing section 38.

Then, at time t15, the light emission ready signal is set to the ON state again. The illumination device 11 emits irradiation light in synchronization with a light emission pulse that is supplied from the distance measurement sensor 12 to the illumination device 11 after the elapse of a fixed time period from setting the light emission ready signal to the ON state of. When the light emission ready signal is set to the ON state at time t15, the calibration operation is not carried out because the calibration enable signal is in the OFF state. The status of the illumination device 11 is the light emission ready state during a time period in which the light emission ready signal is in the ON state. Further, in this state, when the light emission pulse is supplied, the status of the illumination device 11 is changed to the light emission state.

In a case of repeating the irradiation-light emission operation, or repetitively generating microframes, for example, only the light emission ready signal is controlled to either the ON state or the OFF state while the standby signal is normally in the ON state, as in the time period from time t13 to time t15 in FIG. 7.

On the other hand, in a case where it is already known that an irradiation-light emission operation will be not carried out for a fixed time period or longer, the light emission ready signal is controlled to the OFF state, and also, the standby signal is controlled to the OFF state, as in time t16. When the standby signal is set to the OFF state, the status of the illumination device 11 transitions from the light emission ready state to the standby state. Accordingly, in a case where an irradiation-light emission operation is not carried out for a fixed time period or longer, power consumption in the illumination device 11 can be suppressed.

Next, in a case where the irradiation-light emission operation is resumed, control similar to that to be performed on and after time t2 in FIG. 6 is performed.

On the other hand, in a case where the power source of the illumination device 11 is turned off, the power supply signal is set to the OFF (Low) state, so that power supply from the power source supply section 14 to the illumination device 11 is interrupted, as illustrated at time t17. The status of the illumination device 11 transitions from the standby state to the halted state.

In the manner explained so far, the control section 31 of the distance measurement sensor 12 controls the operation state of the illumination device 11 by controlling the ON/OFF states of the standby signal, the calibration enable signal, and the light emission ready signal.

### <7. Timing for Carrying Out Calibration Operation>

To perform the first light emission after the standby signal is changed to the ON state, the control section 31 sets the calibration enable signal to the ON state to control the illumination device 11 such that the illumination device 11 carries out a calibration operation without fail, as previously explained with reference to FIG. 6.

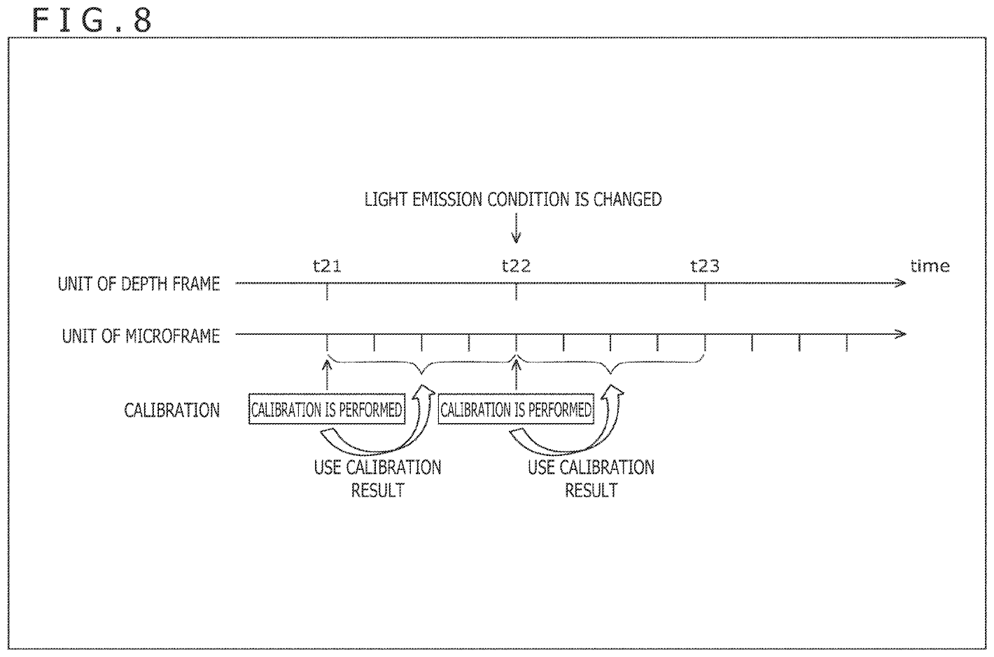

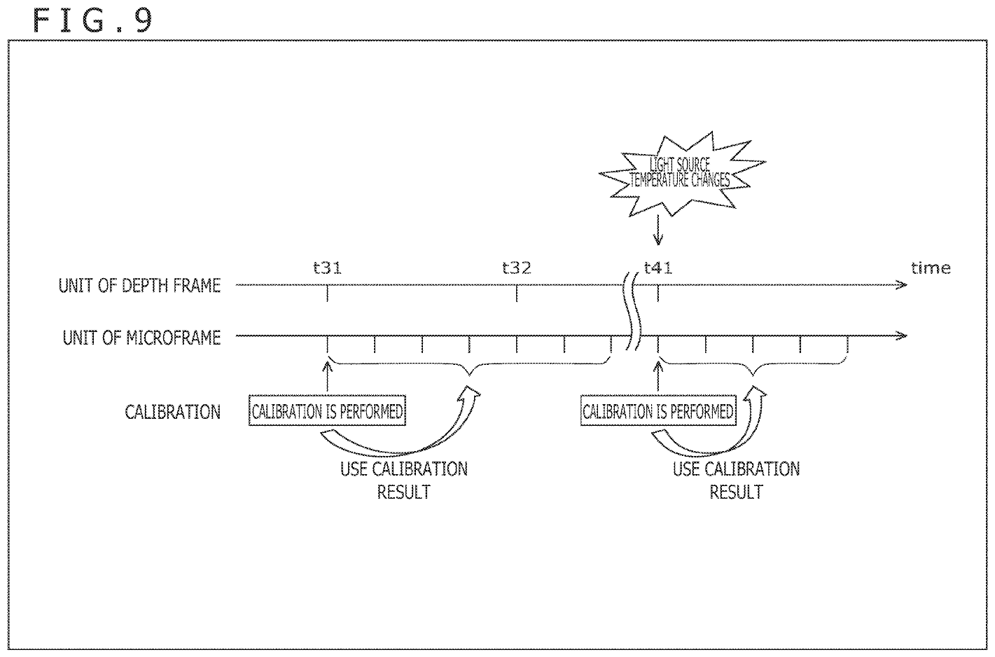

FIGS. 8 and 9 each depict an example of a timing for causing the illumination device 11 to carry out a calibration operation, other than at the first light emission timing after the standby signal is changed to the ON state.

FIG. 8 depicts, as another example of a timing for causing the illumination device 11 to carry out a calibration operation, an example of a light emission condition change timing.

For example, in a case where the first light emission operation after the power supply is performed at time t21 in FIG. 8, the control section 31 controls the illumination device 11 to carry out a calibration operation without fail in the abovementioned manner. Four microframes generated at time t21 or later are based on reflection light resulting from irradiation light applied according to the result of the calibration at time t21 and reflected by an object.

In addition, it is assumed that the light emission condition for application of irradiation light from the illumination device 11 is changed at time t22 for the next unit of depth frame. For example, at time t22, the control section 31 changes the light emission intensity of the irradiation light, and supplies the changed light source setting information to the illumination device 11 via the input/output terminal 41-4. Other possible examples of changed light emission condition include a change of the laser light source, a change of the irradiation area, or a change of the irradiation type. In a case where a change of the laser light source is made, a laser source to emit light is switched in a case where the light emission source 52 includes a plurality of laser light sources. In a case where a change of the irradiation area is made, switching is performed between overall irradiation for irradiating the overall area and partial irradiation for irradiating a limited partial area. In a case where a change of the irradiation type is made, switching is performed between plan irradiation for irradiating a predetermined irradiation area with a uniform light emission intensity within a predetermined intensity range and spot irradiation in which a plurality of spots (circles) arranged at a predetermined interval are set as irradiation areas.

When the light emission condition is changed at time t22, the control section 31 sets the calibration enable signal to the ON state and controls the illumination device 11 to carry out a calibration operation prior to a light emission operation for generating the next microframe. Four microframes generated at time t22 or later are based on reflection light resulting from the irradiation light applied according to the result of the calibration corresponding to the changed light emission condition and reflected by an object. At time t23 at which the light emission condition is not changed, the light emission ready signal is repeatedly turned ON and OFF while no calibration operation is carried out. Accordingly, microframes are generated.

The following FIG. 9 depicts, as a still another example of a timing for causing the illumination device 11 to carry out a calibration operation, an example of a timing at which a temperature change occurs in the illumination device 11.

For example, it is assumed that, at time t31 in FIG. 9, the calibration enable signal is set to the ON state, and a calibration operation is carried out.

The control section 31 of the distance measurement sensor 12 regularly obtains a light source temperature detected by the temperature sensor 53, from the light emission control section 51 of the illumination device 11 via the input/output terminal 54-2 and the input/output terminal 41-4. For example, the control section 31 obtains the light source temperature of the illumination device 11 during a reading time period in which detection signals of the pixels are read out from the pixel array section 37.

Then, in a case where a temperature change which is the difference between a light source temperature obtained from the illumination device 11 in a pixel reading time period of unit of microframes prior to time t41 at which any time period has elapsed from time t31 and a light source temperature obtained at time t31 at which the previous calibration operation is carried out is equal to or greater than a predetermined threshold decided in advance, the control section 31 sets, for generating the next microframe, the calibration enable signal to the ON state and controls the illumination device 11 to carry out a calibration operation. That is, at time t41, the control section 31 sets the calibration enable signal to the ON state and controls the illumination device 11 to carry out a calibration operation prior to a light emission operation for generating the next microframe.

Four microframes generated at time t41 or later are based on reflection light resulting from irradiation light applied according to the result of the calibration at time t41 and reflected by an object.

In the abovementioned manner, the control section 31 can control the illumination device 11 to carry out a calibration operation in a case where a temperature change from the last calibration operation time is equal to or greater than the predetermined threshold.

Alternatively, irrespective of a temperature change, a calibration operation may regularly be carried out each time light emission for generating one microframe is performed a predetermined number of times, for example. Further, a calibration operation may be carried out when a fixed time period or longer has elapsed from the last light emission.

On the other hand, in a case where the temperature change is small (the temperature change falls within a predetermined range) and emission of irradiation light is repeated under the same light emission condition, it is unnecessary to carry out a calibration operation.

The distance measurement sensor 12 recognizes timings for driving the pixels and changes of the light emission condition for the illumination device 11. Hence, the distance measurement sensor 12 can cause the illumination device 11 to carry out a calibration operation at necessary timings.

### <8. Flowchart of Illumination Device Status Control Process>

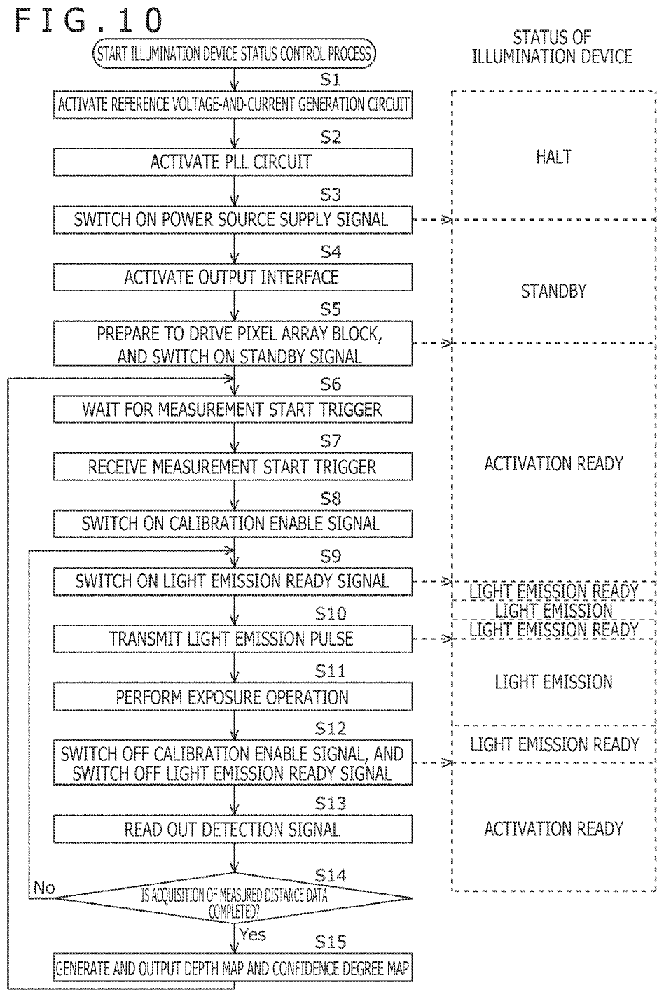

Next, an illumination device status control process which is performed by the control section 31 of the distance measurement sensor 12 will be explained with reference to the flowchart in FIG. 10. It is to be noted that the status change of the illumination device 11 is additionally illustrated on the right side in FIG. 10. This process is started upon supply of an activation request from the host control section 13 to the distance measurement sensor 12, for example.

First, in step S1, the control section 31 of the distance measurement sensor 12 activates the reference voltage-and-current generation circuit 32. Next, in step S2, the control section 31 activates the PLL circuit 33. When the reference voltage-and-current generation circuit 32 and the PLL circuit 33 are activated, a predetermined period of time is required to stabilize the operations of these circuits.

Next, in step S3, the control section 31 controls the power supply signal to the ON state to cause the power source supply section 14 to supply a power source to the illumination device 11. In step S4, the control section 31 activates the output IF 40. Since the power supply signal is in the ON state, the status of the illumination device 11 transitions from the halted state which is the initial state to the standby state.

Next, in step S5, the control section 31 prepares to drive the pixel array block 42, and performs control to set the standby signal to the ON state. As a result of setting the standby signal to the ON state, the status of the illumination device 11 transitions from the standby state to the activation ready state.

In step S6, the control section 31 enters a state of waiting for a measurement start trigger from the host control section 13. Receiving a measurement start trigger in step S7, the control section 31 performs control to set the calibration enable signal to the ON state in step S8.

In step S9, the control section 31 performs control to set the light emission ready signal to the ON state. As a result of setting the light emission ready signal to the ON state, the status of the illumination device 11 transitions from the activation ready state to the light emission ready state. A calibration operation is carried out because the calibration enable signal is also in the ON state when the light emission ready signal is set to the ON state. During the calibration operation, the status of the illumination device 11 is the light emission state.

Next, in step S10, the light emission timing control section 34 generates a light emission pulse, and transmits the light emission pulse to the illumination device 11 during a predetermined light emission time period set under the light emission condition. The illumination device 11 applies irradiation light according to the light emission pulse, and the status of the illumination device 11 is changed to the light emission state.

In step S11, the light emission timing control section 34 generates a light reception pulse for receiving reflection light in synchronization with the light emission pulse, and supplies the light reception pulse to the pixel modulation section 35. Under the control of the pixel modulation section 35 and the pixel control section 36, the pixel array section 37 performs an exposure operation for receiving reflection light. More specifically, the pixel modulation section 35 switches an electric charge storing operation between the first tap and the second tap in each pixel in the pixel array section 37, according to the light reception pulse supplied from the light emission timing control section 34.

After supply of the light emission pulse is halted, the status of the illumination device 11 is changed to the light emission ready state.

In step S12, the control section 31 performs control to set both the calibration enable signal and the light emission ready signal to the OFF state. As a result of this, the status of the illumination device 11 transitions from the light emission ready state to the activation ready state.

In step S13, the pixel array block 42 reads out a detection signal corresponding to the electric charge stored in each pixel in the pixel array section 37, the column processing section 38 performs AD conversion on the detection signal, and the resultant signal is supplied to the data processing section 39.

In step S14, the control section 31 determines whether or not acquisition of measured distance data is completed. That is, in step S14, it is determined that acquisition of measured distance data is completed in a case where generation of depth frames (microframes) that are necessary to generate a depth map is completed.

In a case where it is determined in step S14 that acquisition of measured distance data is not yet completed, the process returns to step S9, and then, steps S9 to S14 described above are performed again.

On the other hand, in a case where it is determined in step S14 that acquisition of measured distance data is completed, the process proceeds to step S15 where the data processing section 39 generates and outputs a depth map and a confidence degree map. That is, the data processing section 39 generates a depth map with one or more depth frames. Further, the data processing section 39 generates a confidence degree map corresponding to the depth map. The generated depth map and confidence degree map are converted, at the output IF 40, into a predetermined signal format, and are then outputted to the host control section 13 through the input/output terminal 41-6.

After step S15, the process returns to step S6, and then, step S6 and the following steps described above are performed again. That is, the distance measurement sensor 12 enters a state of waiting for a measurement start trigger again. When the distance measurement sensor 12 receives a measurement start trigger, the distance measurement sensor 12 performs control to cause emission of irradiation light and exposure to reflection light according to a light emission timing of the irradiation light.

However, step S8 of setting the calibration enable signal to the ON state, which corresponds to a calibration operation, can be omitted, as appropriate. In this case, control to carry out a calibration operation is performed when the light emission condition is changed or a temperature change is equal to or greater than a predetermined threshold, as previously explained.

According to the above illumination device status control process, the distance measurement sensor 12 acquires a light emission condition and a measurement start trigger from the host control section 13, and causes the illumination device 11 to emit irradiation light according to a timing or a condition designated by the host control section 13. The distance measurement sensor 12 is aware of a timing for emitting irradiation light, and is further aware of an operation timing of the distance measurement sensor 12 itself. Hence, the distance measurement sensor 12 performs detailed status control on the illumination device 11 according to the operation timing of the distance measurement sensor 12 itself. Accordingly, control to minimize a time period in which power consumption in the illumination device 11 is large can be performed, so that power consumption in the illumination device 11 can be reduced.

### <9. Modification of Distance Measurement Sensor>

A modification of the distance measurement sensor 12 will be explained.

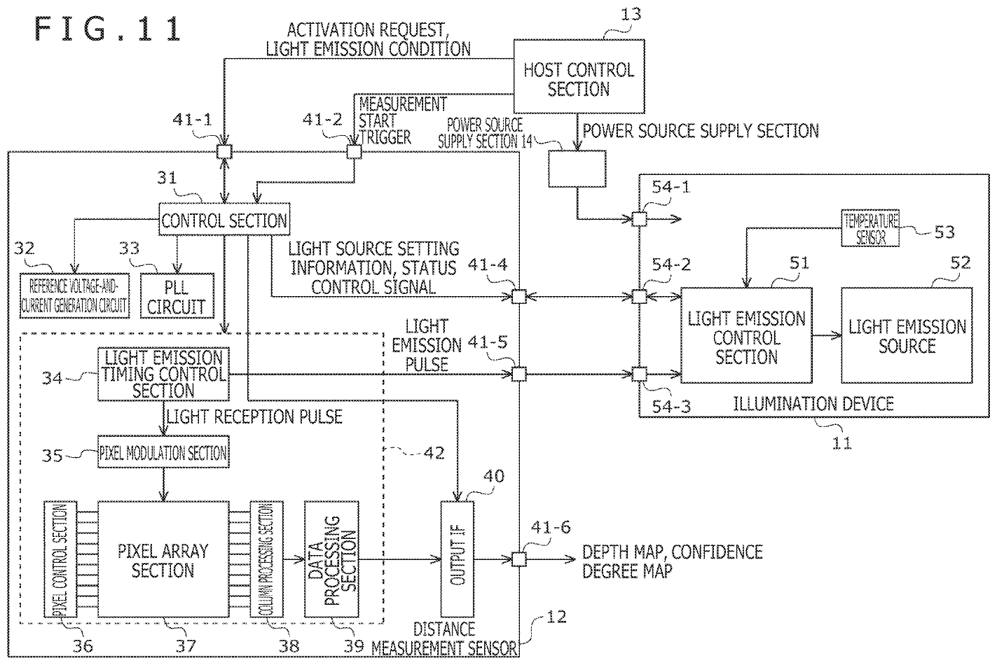

FIG. 11 is a block diagram depicting a detailed configuration example of the illumination device 11 and the distance measurement sensor 12 according to the modification.

In FIG. 11, the sections corresponding to those in the illumination device 11 and the distance measurement sensor 12 explained with reference to FIG. 4 are denoted by the same reference signs, and an explanation thereof will be omitted.

The distance measurement sensor 12 in FIG. 11 does not control supply of a power source to the illumination device 11. The host control section 13 performs the control.

More specifically, the control section 31 of the distance measurement sensor 12 supplies the power source control signal to the power source supply section 14 via the input/output terminal 41-3 in FIG. 4, whereas the host control section 13 supplies the power source control signal to the power source supply section 14 in FIG. 11. Hence, the input/output terminal 41-3 of the distance measurement sensor 12 is omitted.

Supply of a power source may be managed by the host apparatus side. In that case, the host control section 13 can be configured to supply the power source control signal to the power source supply section 14, as depicted in FIG. 11.

It is to be noted that, in a case where turning on/off of a power source cannot be efficiently conducted, power source control may be omitted. In this case, the control section 31 of the distance measurement sensor 12 may control only four statuses which are the light emission state, the light emission ready state, the activation ready state, and the standby state, in the activated state while the power source for the illumination device 11 is always set to the ON state.

### <10. Chip Configuration Example of Distance Measurement Sensor>

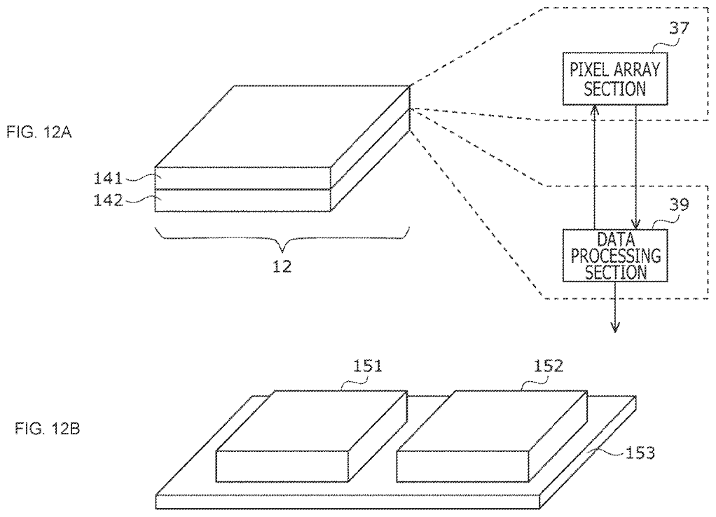

FIG. 12 depicts perspective views of a chip configuration example of the distance measurement sensor 12.

As depicted in A of FIG. 12, the distance measurement sensor 12 can include a single chip in which a first die (substrate) 141 and a second die (substrate) 142 are layered.

For example, at least the pixel array section 37 serving as a light reception section is disposed on the first die 141. For example, the data processing section 39 that generates a depth frame and a depth map by using detection signals outputted from the pixel array section 37 is disposed on the second die 142.

It is to be noted that the distance measurement sensor 12 may include three layers which are the first die 141, the second die 142, and another logic die, or may include four or more layered dies (substrates).

Alternatively, some of the functions of the distance measurement sensor 12 may be implemented by a signal processing chip separate from the distance measurement sensor 12. As depicted in B of FIG. 12, for example, a sensor chip 151 serving as the distance measurement sensor 12 and a logic chip 152 that performs later-stage signal processing may be formed on a relay substrate 153. The logic chip 152 may be configured to perform a portion of the abovementioned processing to be performed by the data processing section 39 of the distance measurement sensor 12, for example, processing to generate a depth frame and a depth map or the like.

<11. Comparison with Any Other Light Emission Control Method>

In the abovementioned distance measurement system 1, the distance measurement sensor 12 is configured to control the status of the illumination device 11 according to an operation timing of the distance measurement sensor 12 itself.

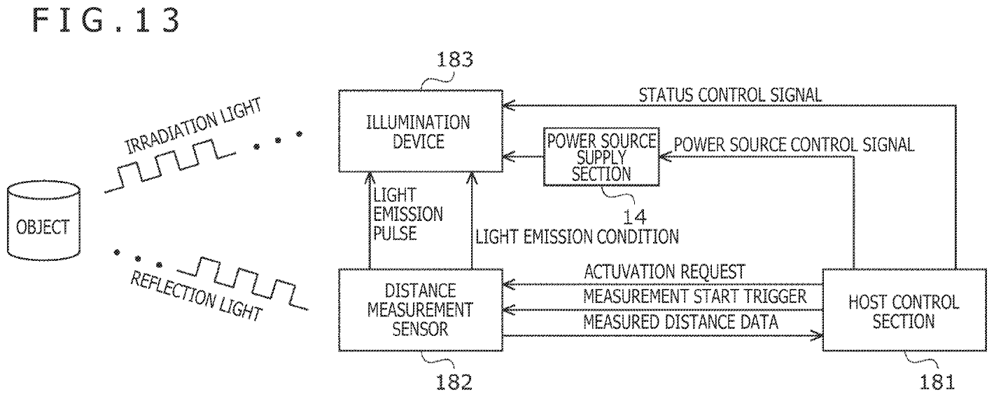

In contrast, there is another method in which a host control section 181 supplies a status control signal to an illumination device 183, as depicted in FIG. 13, such that the status of the illumination device 11 is controlled.

In such a control method, after the host control section 181 transmits a measurement start trigger to the distance measurement sensor 182, a timing at which the distance measurement sensor 182 outputs a light emission pulse to the illumination device 183 remains unclear. A timing at which the distance measurement sensor 182 receives light also remains unclear. Hence, detailed control cannot be performed on the status of the illumination device 183. In addition, when the host control section 181 tries to identify a light emission timing (light emission pulse) of the illumination device 183 or the timing of the light receiving operation of the distance measurement sensor 182, a load on the host control section 181 becomes large.

In contrast, in the distance measurement system 1 in FIG. 1, the distance measurement sensor 12 performs detailed control on the status of the illumination device 11 according to an operation timing of the distance measurement sensor 12 itself. Accordingly, power consumption in the illumination device 11 can be further reduced. In addition, the distance measurement system 1 can perform a standalone operation without depending on the host control section 13. Accordingly, a load on the host control section 13 can be reduced. This can make a contribution to reduction in the total power consumption in the host apparatus having the distance measurement system 1 installed therein.

The control method for the status of the illumination device 11 by the distance measurement system 1 in FIG. 1 is applicable not only to indirect ToF distance measurement systems, but also to Structured Light distance measurement systems and direct ToF distance measurement systems.

### <12. Examples of Application to Electronic Apparatus>

The abovementioned distance measurement system 1 may be installed in an electronic apparatus such as a smartphone, a tablet terminal, a mobile phone, a personal computer, a game machine, a television receiver, a wearable terminal, a digital still camera, or a digital video camera, for example.

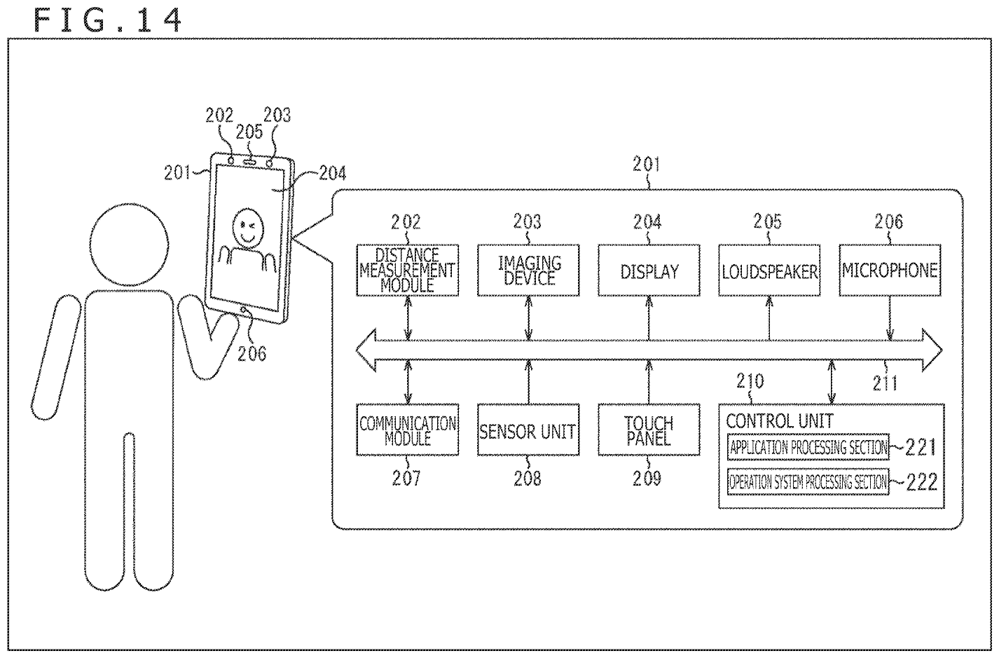

FIG. 14 is a block diagram depicting a configuration example of a smartphone which is an electronic apparatus having the distance measurement system 1 installed therein.

As depicted in FIG. 14, a smartphone 201 is formed by connecting a distance measurement module 202, an imaging device 203, a display 204, a loudspeaker 205, a microphone 206, a communication module 207, a sensor unit 208, a touch panel 209, and a control unit 210 to one another via a bus 211. Further, in the control unit 210, a CPU executes a program to implement the functions of an application processing section 221 and an operation system processing section 222.

The distance measurement system 1 in FIG. 1 is applied to the distance measurement module 202. For example, the distance measurement module 202 is disposed on the front surface of the smartphone 201, and can measure the distance to a user of the smartphone 201. As a result, the distance measurement module 202 can output, as a distance measurement result, a depth value of a surface shape of the face, a hand, or a finger of the user. The host control section 13 in FIG. 1 corresponds to the control unit 210 in FIG. 14.

The imaging device 203 is disposed on the front surface of the smartphone 201, and obtains an image of the user of the smartphone 201 by imaging the user. It is to be noted that the imaging device 203 may be disposed additionally on the rear surface of the smartphone 201, which is not depicted in FIG. 14.

The display 204 displays an operation screen for processing to be performed by the application processing section 221 and the operation system processing section 222 and an image obtained by the imaging device 203, for example. The loudspeaker 205 and the microphone 206 output a conversation partner's voice, and collect a voice of the user when a conversation is conducted through the smartphone 201, for example.

The communication module 207 performs communication over a communication network. The sensor unit 208 performs sensing of a speed, an acceleration, approach, etc. The touch panel 209 obtains a touch operation made, on the operation screen being displayed on the display 204, by the user.

The application processing section 221 performs processing for providing a variety of services through the smartphone 201. For example, the application processing section 221 can perform a process of creating a computer graphic face virtually representing the user's expression, and displaying the face on the display 204, in reference to a depth map supplied from the distance measurement module 202. Further, the application processing section 221 can perform a process of creating 3D data on any 3D object, for example, in reference to a depth map supplied from the distance measurement module 202.

The operation system processing section 222 performs processing for implementing basic function and operation of the smartphone 201. For example, the operation system processing section 222 can authenticate the user's face in reference to a depth map supplied from the distance measurement module 202, and unlock the smartphone 201. In addition, the operation system processing section 222 can perform a process of recognizing a gesture made by the user, for example, in reference to a depth map supplied from the distance measurement module 202, and inputting various operations according to the gesture.

When the abovementioned distance measurement system 1 is applied to the smartphone 201 configured as described above, power consumption in the distance measurement module 202 can be reduced, and a load on the control unit 210 also can be reduced. Accordingly, the total power consumption in the smartphone 201 can be reduced.

### <13. Examples of Application to Mobile Body>

The technology (present technology) according to the present disclosure is applicable to a variety of products. For example, the technology according to the present disclosure may be implemented as a device to be mounted on a mobile body of any one of the types including an automobile, an electric automobile, a hybrid electric automobile, a motor bicycle, a bicycle, a personal mobility, an aircraft, a drone, a ship, a robot, and the like.

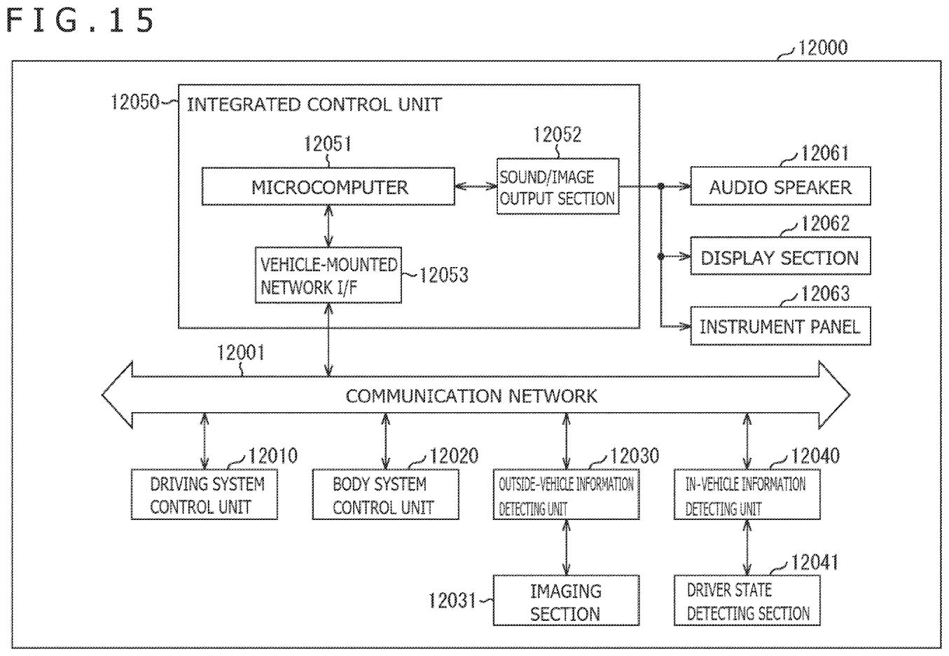

FIG. 15 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 15, an audio speaker 12061, a display section 12062, and an instrument panel 12063 are illustrated as the output device. The display section 12062 may, for example, include at least one of an on-board display and a head-up display.

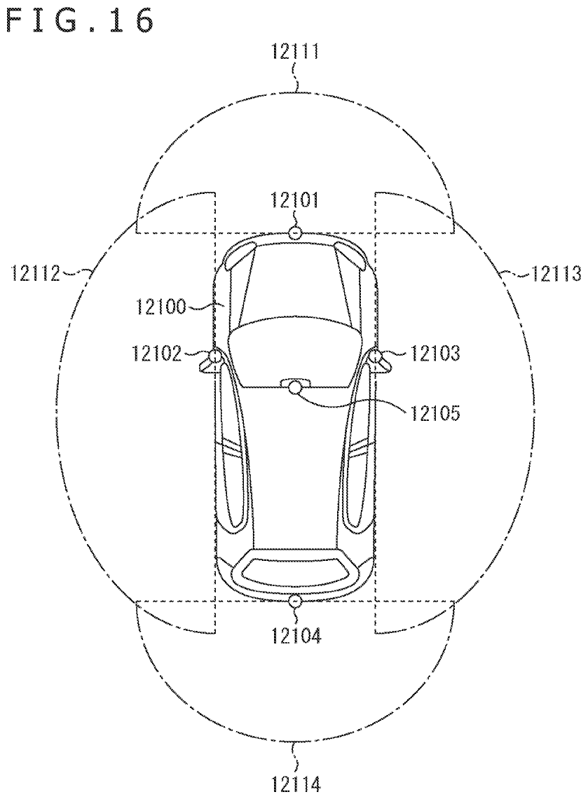

FIG. 16 is a diagram depicting an example of the installation position of the imaging section 12031.

In FIG. 16, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of a vehicle control system to which the technology according to the present disclosure is applicable has been explained above. The technology according to the present disclosure is applicable to the outside-vehicle information detecting unit 12030 or the in-vehicle information detecting unit 12040 in the abovementioned configuration. Specifically, distance measurement with the distance measurement system 1 is used for the outside-vehicle information detecting unit 12030 or the in-vehicle information detecting unit 12040, so that a process of recognizing a gesture made by the driver is performed. Accordingly, an operation (e.g., an operation for an audio system, an operation for a navigation system, or an operation for an air conditioning system) according to the gesture can be executed, or the state of the driver can be more precisely detected. In addition, distance measurement with the distance measurement system 1 can be used to recognize projections and recesses on a road surface, and the recognized projections and recesses can be reflected in control of the suspension. Further, these processes (operations) can be executed with lower power consumption.

The embodiments of the present technology are not limited to the abovementioned embodiment, and various changes can be made within the scope of the gist of the present technology.

A plurality of the aspects of the present technique explained herein can be implemented independently and singly as long as there is no inconsistency. It goes without saying that any aspects of the present technique can be implemented in combination. In addition, any part or the entirety of the abovementioned present technique can be implemeted in combination with another technique which has not been explained above.

In addition, for example, a configuration explained as one device (or processing section) may be divided into a plurality of devices (or processing sections). In contrast, a configuration explained as a set of a plurality of devices (or processing sections) may be integrated into one device (or processing section). Also, a configuration other than the abovementioned configurations may be added to the configuration of each device (or each processing section). Further, as long as the configuration or operation of the entire system is not changed, a partial configuration of a certain device (or processing section) may be included in the configuration of another device (or another processing section).

Moreover, the term “system” in the present description. means a set of multiple constituent components (devices, modules (components), etc.), and whether or not all the constituent components are included in the same casing does not matter. Hence, a set of multiple devices that are housed in different casings and are connected. over a network. is a system, and further, a single device having multiple modules housed in a single casing is also a system.

It is to be noted that the effects described in the present description are mere examples, and thus, are not limitative. Any other effect may be provided.

It is to be noted that the present technology may have the following configurations.

(1)

A distance measurement sensor including:

a pixel array section where pixels that each receive reflection light resulting from irradiation light applied by an illumination device and reflected by an object and output a detection signal according to a quantity of the received light are two-dimensionally arranged; and

a control section that controls an operation state of the illumination device according to an operation timing of the distance measurement sensor itself.

(2)

The distance measurement sensor according to (1), in which

the control section controls the operation state of the illumination device in line with driving of the pixels.

(3)

The distance measurement sensor according to (1) or (2), in which,

during a reading time period of reading out the detection signals from the pixels, the control section controls the operation state of the illumination device such that power consumption becomes smaller than that during a light emission state.

(4)

The distance measurement sensor according to any one of (1) to (3), in which,

when first light emission is performed after power supply, the control section controls the illumination device to carry out a calibration operation.

(5)

The distance measurement sensor according to any one of (1) to (4), in which

the control section further controls a light emission condition for emission of the irradiation light from the illumination device.

(6)

The distance measurement sensor according to (5), in which,

in a case where the light emission condition is changed, the control section controls the illumination device to carry out a calibration operation.

(7)

The distance measurement sensor according to any one of (1) to (6), in which,

in a case where a temperature change in the illumination device is equal to or greater than a predetermined threshold, the control section controls the illumination device to carry out a calibration operation.

(8)

The distance measurement sensor according to any one of (1) to (7), in which

the control section controls the operation state of the illumination device by serial communication.

(9)

A distance measurement system including:

an illumination device that applies irradiation light to an object;

a distance measurement sensor that receives reflection light resulting from the irradiation light reflected by the object, in which

the distance measurement sensor includes
a pixel array section where pixels that each output a detection signal according to a quantity of the received reflection light are two-dimensionally arranged, and
a control section that controls an operation state of the illumination device according to an operation timing of the distance measurement sensor itself.
   (10)

An electronic apparatus including:

a distance measurement system that includes
an illumination device that applies irradiation light to an object, and
a distance measurement sensor that receives reflection light resulting from the illumination light reflected by the object,
the distance measurement sensor including
   a pixel array section where pixels that each output a detection signal according to a quantity of the received reflection light are two-dimensionally arranged, and
   a control section that controls an operation state of the illumination device according to an operation timing of the distance measurement sensor itself.

### REFERENCE SIGNS LIST

1: Distance measurement system

11: Illumination device

12: Distance measurement sensor

13: Host control section

14: Power source supply section

31: Control section

32: Reference voltage-and-current generation circuit

33: PLL circuit

34: Light emission timing control section

37: Pixel array section

39: Data processing section

40: Output section

42: Pixel array block

51: Light emission control section

52: Light emission source

53: Temperature sensor

201: Smartphone

202: Distance measurement module

1. A distance measurement sensor comprising:
a pixel array section where pixels that each receive reflection light resulting from irradiation light applied by an illumination device and reflected by an object and output a detection signal according to a quantity of the received light are two-dimensionally arranged; and
a control section that controls an operation state of the illumination device according to an operation timing of the distance measurement sensor itself.

2. The distance measurement sensor according to claim 1, wherein
the control section controls the operation state of the illumination device in line with driving of the pixels.

3. The distance measurement sensor according to claim 1, wherein,
during a reading time period of reading out the detection signals from the pixels, the control section controls the operation state of the illumination device such that power consumption becomes smaller than that during a light emission state.

4. The distance measurement sensor according to claim 1, wherein,
when first light emission is performed after power supply, the control section controls the illumination device to carry out a calibration operation.

5. The distance measurement sensor according to claim 1, wherein
the control section further controls a light emission condition for emission of the irradiation light from the illumination device.

6. The distance measurement sensor according to claim 5, wherein,
in a case where the light emission condition is changed, the control section controls the illumination device to carry out a calibration operation.

7. The distance measurement sensor according to claim 1, wherein,
in a case where a temperature change in the illumination device is equal to or greater than a predetermined threshold, the control section controls the illumination device to carry out a calibration operation.

8. The distance measurement sensor according to claim 1, wherein
the control section controls the operation state of the illumination device by serial communication.

9. A distance measurement system comprising:
an illumination device that applies irradiation light to an object;
a distance measurement sensor that receives reflection light resulting from the irradiation light reflected by the object, wherein
the distance measurement sensor includes
a pixel array section where pixels that each output a detection signal according to a quantity of the received reflection light are two-dimensionally arranged, and
a control section that controls an operation state of the illumination device according to an operation timing of the distance measurement sensor itself.

10. An electronic apparatus comprising:
a distance measurement system that includes
an illumination device that applies irradiation light to an object, and
a distance measurement sensor that receives reflection light resulting from the illumination light reflected by the object,
the distance measurement sensor including
a pixel array section where pixels that each output a detection signal according to a quantity of the received reflection light are two-dimensionally arranged, and
a control section that controls an operation state of the illumination device according to an operation timing of the distance measurement sensor itself.
